(19) United States
(12) Patent Application Publication
(10) Pub. No.: US 2025/0171219 A1
(43) Pub. Date: May 29, 2025

(54) POWDER SUPPLY CONTAINER

(71) Applicant: SEIKO EPSON CORPORATION, Tokyo (JP)

(72) Inventors: Yoko YAMAZAKI, Azumino (JP); Masamitsu SHIMAZU, Matsumoto (JP); Toshizo NISHI, Azumino (JP); Yutaro MASUKO, Matsumoto (JP)

(21) Appl. No.: 18/961,550

(22) Filed: Nov. 27, 2024

(30) Foreign Application Priority Data
Nov. 29, 2023 (JP) 2023-201435

(51) Int. Cl. B65D 83/06; B65D 77/04

(52) U.S. Cl. CPC B65D 83/06; B65D 77/0486

(57) ABSTRACT

A powder supply container includes a first case having an internal space having a columnar shape; and a second case disposed to overlap the internal space to be rotatable around a central axis of the internal space, and an opening/closing of an opening portion that opens the internal space follows a rotation of the second case.

The present application is based on, and claims priority from JP Application Serial Number 2023-201435, filed Nov. 29, 2023, the disclosure of which is hereby incorporated by reference herein in its entirety.

### BACKGROUND

### 1. Technical Field

The present disclosure relates to a powder supply container.

### 2. Related Art

In the related art, a powder supply container that supplies powder such as a material, an additive, or the like to a manufacturing apparatus has been known. For example, JP-A-2000-61282 discloses a mixing apparatus that mixes and discharges a particulate material.

In a relatively small manufacturing apparatus, an operation may involve manually filling a powder supply container with powder, and then carrying the powder supply container by hand and mounting the powder supply container on a manufacturing apparatus. In this case, there has been a demand for a powder supply container that is easy to carry in a state where the powder supply container is filled with powder.

### SUMMARY

A powder supply container includes a first case having an internal space having a columnar shape, a second case disposed to overlap the internal space to be rotatable around a central axis of the internal space, a first lid including an opening portion, a second lid, and a shutter.

The first lid closes a first direction side of the central axis of the internal space in a state where the opening portion is closed by the shutter, the second lid closes a second direction side of the central axis of the internal space opposite to a first direction, and the shutter follows a rotation of the second case to open and close the opening portion.

### BRIEF DESCRIPTION OF THE DRAWINGS

FIG. 1 is a perspective view illustrating an appearance of a powder supply container according to an embodiment.

FIG. 2 is an exploded perspective view illustrating a configuration of the powder supply container.

FIG. 3 is a perspective view illustrating a configuration of a first lid portion.

FIG. 4 is an exploded perspective view illustrating the configuration of the first lid portion.

FIG. 5 is a perspective view illustrating a state where a first cylindrical portion and a second cylindrical portion are assembled.

FIG. 6 is a perspective view illustrating a state where the first cylindrical portion, the second cylindrical portion, and a second lid portion are assembled.

FIG. 7 is a perspective sectional view illustrating the disposition of each configuration in the powder supply container.

FIG. 8 is a perspective view illustrating the disposition of a rotation restriction portion of the first cylindrical portion and a projection portion of the second cylindrical portion.

FIG. 9 is a perspective view illustrating a state where an opening portion is closed.

FIG. 10 is a perspective view illustrating a state where the opening portion is opened.

FIG. 11 is a perspective view illustrating a state where the powder supply container is mounted on a powder supply mechanism.

FIG. 12 is a schematic view illustrating a configuration of a sheet manufacturing apparatus to which the powder supply container is applied.

### DESCRIPTION OF EMBODIMENTS

In the following embodiment, a powder supply container 200 that is applied to a sheet manufacturing apparatus that manufactures a sheet from paper pieces will be provided as an example, and will be described with reference to the drawings. The powder supply container 200 supplies powder such as an additive to the sheet manufacturing apparatus.

In each of the following drawings, an F-axis is designated as a virtual axis, a direction indicated by an arrow is a +F direction, and a direction opposite to the +F direction is a −F direction. The +F direction corresponds to a first direction of the present disclosure, and the −F direction corresponds to a second direction of the present disclosure.

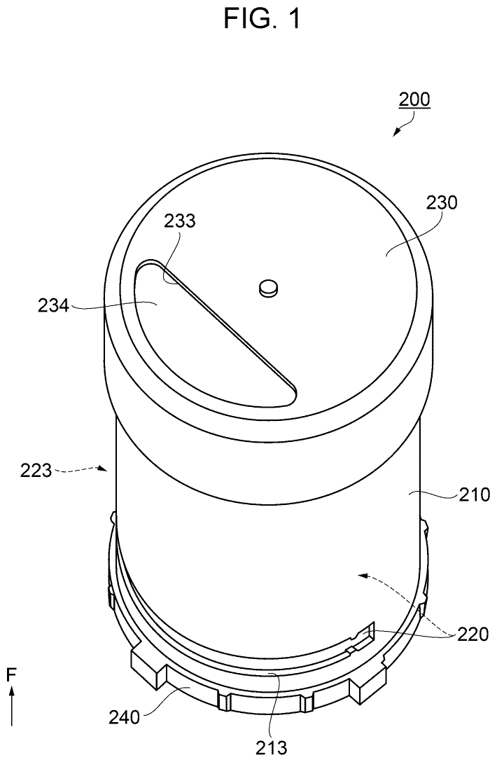

As illustrated in FIG. 1, the powder supply container 200 has a substantially columnar appearance, and a cross section perpendicular to the F-axis has a substantially circular shape. In the powder supply container 200 having a substantially columnar shape, a height direction of the column is along the F-axis. The inside of the powder supply container 200 is filled with powder such as powder or granules. The powder supply container 200 is sealed in a state where the powder supply container 200 contains the powder, and can be carried or stored in this state.

The powder supply container 200 includes a first cylindrical portion 210, a second cylindrical portion 220, a first lid portion 230, and a second lid portion 240, and is formed by assembling these configurations. In the powder supply container 200, the second lid portion 240, the first cylindrical portion 210 and the first lid portion 230 are disposed in order from the −F direction toward the +F direction. The second cylindrical portion 220 is disposed inside the first cylindrical portion 210.

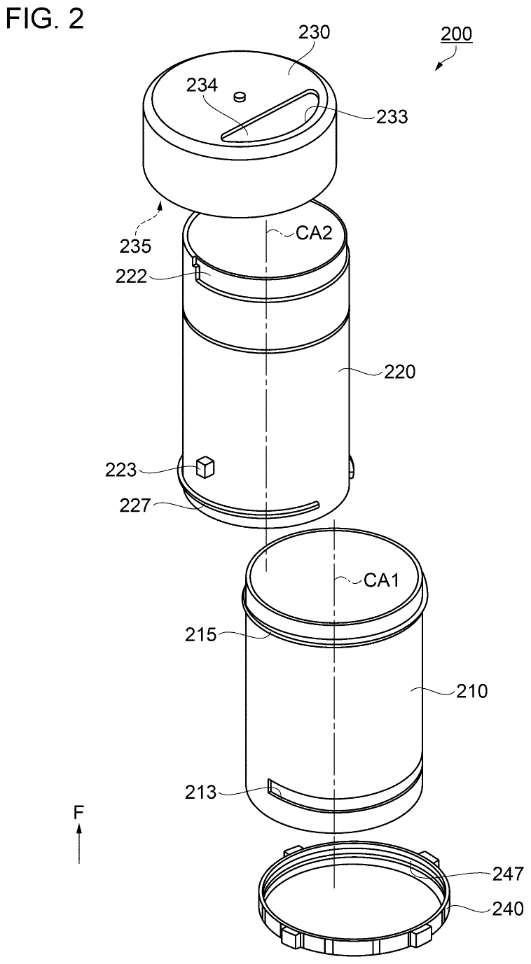

The first cylindrical portion 210 includes a rotation restriction portion 213. The second cylindrical portion 220 includes a projection portion 223. The first lid portion 230 includes an opening portion 233 and a shutter portion 234. FIG. 1, FIG. 2 to be described later, and the like illustrate a state where the opening portion 233 is closed by the shutter portion 234.

As illustrated in FIG. 2, the first cylindrical portion 210 includes the rotation restriction portion 213 and a male screw portion 215. The first cylindrical portion 210 has a substantially cylindrical shape, and has a central axis CA1 along the F-axis. A cross section of the first cylindrical portion 210 perpendicular to the central axis CA1 has a substantially circular shape.

The male screw portion 215 is disposed in the vicinity of a +F direction end portion on a side surface of the first cylindrical portion 210. The male screw portion 215 is screwed to a female screw portion 235 of the first lid portion 230.

The rotation restriction portion 213 is disposed in the vicinity of a −F direction end portion of the side surface of the first cylindrical portion 210. The rotation restriction portion 213 is provided at a position corresponding to the projection portion 223 of the second cylindrical portion 220. The rotation restriction portion 213 is an opening penetrating through the side surface of the first cylindrical portion 210. The rotation restriction portion 213 has a substantially rectangular shape when viewed in a direction perpendicular to the F-axis, and a longitudinal direction of the rotation restriction portion 213 is along the −F direction end portion of the first cylindrical portion 210.

The rotation restriction portion 213 may be a hole in the side surface of the first cylindrical portion 210, the periphery of the hole being surrounded by the side surface as illustrated in FIG. 2, or may be a cutout continuous with the −F direction end portion of the side surface of the first cylindrical portion 210.

The second cylindrical portion 220 includes a groove portion 222, the projection portion 223, and a male screw portion 227. The second cylindrical portion 220 has a substantially cylindrical shape, and has a central axis CA2 along the F-axis. In a direction along the F-axis, a length of the second cylindrical portion 220 is slightly longer than a length of the first cylindrical portion 210. A cross section of the second cylindrical portion 220 perpendicular to the central axis CA2 has a substantially circular shape.

In the cross section, a diameter of the second cylindrical portion 220 is smaller than a diameter of the first cylindrical portion 210. For that reason, the second cylindrical portion 220 can be contained inside the first cylindrical portion 210.

The groove portion 222 is disposed at a +F direction end portion of a side surface of the second cylindrical portion 220. The groove portion 222 is provided at a position corresponding to the shutter portion 234 of the first lid portion 230. The groove portion 222 is formed to be thinner than regions other than the groove portion 222 on the side surface of the second cylindrical portion 220. The groove portion 222 has a substantially rectangular shape when viewed in the direction perpendicular to the F-axis, and a longitudinal direction of the groove portion 222 is along a +F direction end portion of the second cylindrical portion 220.

The male screw portion 227 is disposed in the vicinity of a −F direction end portion on the side surface of the second cylindrical portion 220. The male screw portion 227 is screwed to a female screw portion 247 of the second lid portion 240.

The projection portion 223 is disposed in the +F direction with respect to the male screw portion 227 on the side surface of the second cylindrical portion 220. The projection portion 223 is provided to protrude from the side surface, corresponds to the rotation restriction portion 213 of the first cylindrical portion 210, and is fitted into the rotation restriction portion 213. If the rotation restriction portion 213 is a cutout of the first cylindrical portion 210, the projection portion 223 is fitted through the cutout; however, if the rotation restriction portion 213 is not a cutout of the first cylindrical portion 210, the second cylindrical portion 220 is fitted into the first cylindrical portion 210, and then the projection portion 223 is attached.

The first lid portion 230 is composed of the cylindrical side surface and an upper surface facing in the +F direction. The opening portion 233 is disposed in the upper surface. The opening portion 233 is an opening having a substantially semicircular shape when viewed from the +F direction, and an arc-shaped region is disposed along an outer periphery of the upper surface. In the direction along the F-axis, a length of the first lid portion 230 is shorter than the length of the first cylindrical portion 210. Although not particularly limited, in the direction along the F-axis, the length of the first lid portion 230 is, for example, approximately one-fourth the length of the first cylindrical portion 210.

A cross section of the first lid portion 230 taken along a plane perpendicular to the F-axis has a substantially circular shape. A diameter of the first lid portion 230 in the cross section is slightly larger than a diameter of a cross section of the first cylindrical portion 210 along the central axis CA1.

In the first lid portion 230, the female screw portion 235 is provided in the vicinity of the −F direction end portion on an inner side of the side surface. The female screw portion 235 is screwed to the male screw portion 215 of the first cylindrical portion 210.

The shutter portion 234 is attached to an inner side of the upper surface of the first lid portion 230. The opening portion 233 can be opened and closed by the shutter portion 234.

The second lid portion 240 is composed of a lower surface having a substantially circular shape when viewed from the +F direction, and an edge (not illustrated) rising from the lower surface in the +F direction. In the direction along the F-axis, a length of the edge is shorter than a length between the rotation restriction portion 213 of the first cylindrical portion 210 and the −F direction end portion of the first cylindrical portion 210.

A cross section of the second lid portion 240 taken along a plane perpendicular to the F-axis has a substantially circular shape. A diameter of the second lid portion 240 in the cross section is slightly larger than the diameter of the cross section of the first cylindrical portion 210 along the central axis CA1.

The female screw portion 247 corresponding to the male screw portion 227 of the second cylindrical portion 220 is provided on an inner side of the edge.

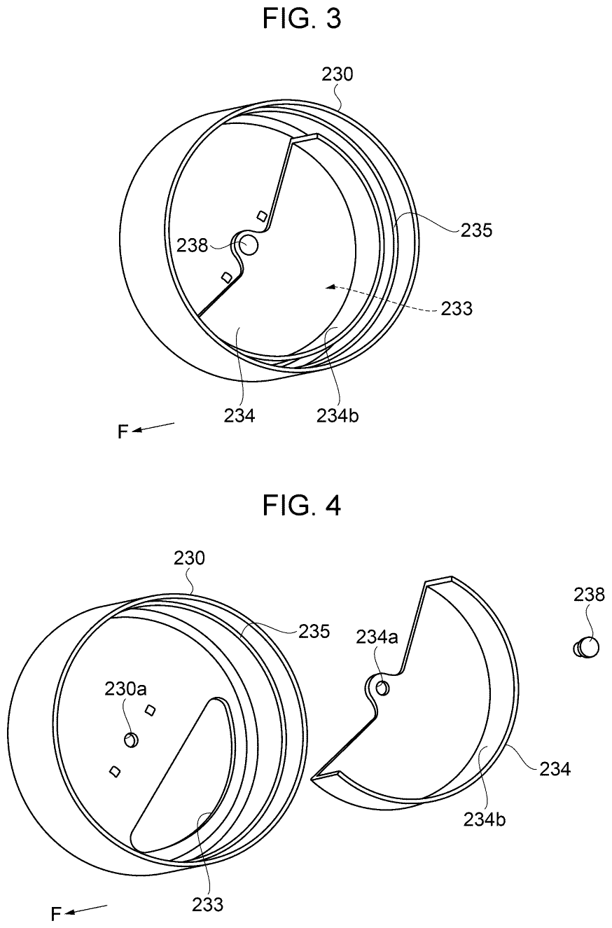

As illustrated in FIGS. 3 and 4, the first lid portion 230 includes a bearing hole 230a, the shutter portion 234, an attachment hole 234a, the female screw portion 235, and a shaft portion 238. The bearing hole 230a is disposed at the center of the upper surface of the first lid portion 230.

The shutter portion 234 is disposed inside the first lid portion 230. The shutter portion 234 includes a region having a substantially fan shape when viewed from the −F direction, and an edge portion 234b extending in the −F direction from the circumference of the fan shape. In the direction along the F-axis, a length of the edge portion 234b is shorter than a length of the side surface of the first lid portion 230.

In the region having a substantially fan shape, an angle formed by two radii of the fan shape is, for example, substantially 190°. The two radi are smaller than a radius of a cross section of the side surface of the first lid portion 230. The substantially fan-shaped region of the shutter portion 234 is large enough to close the opening portion 233.

The attachment hole 234a is disposed in the vicinity of a region corresponding to the intersection point of the two radii. When the shutter portion 234 and the first lid portion 230 are assembled, the attachment hole 234a and the bearing hole 230a overlap each other. The shaft portion 238 is inserted into the attachment hole 234a and the bearing hole 230a that are overlapped.

The shaft portion 238 is fixed to the upper surface of the first lid portion 230. The shutter portion 234 is not fixed to the shaft portion 238, but is supported by the shaft portion 238 and rotates about the shaft portion 238. When the powder supply container 200 is assembled, the central axis CA1 passes through the shaft portion 238. That is, the shutter portion 234 is rotatable about the central axis CA1.

When the first lid portion 230 is assembled, the female screw portion 235 is provided further in the −F direction with respect to an −F direction end portion of the edge portion 234b of the shutter portion 234.

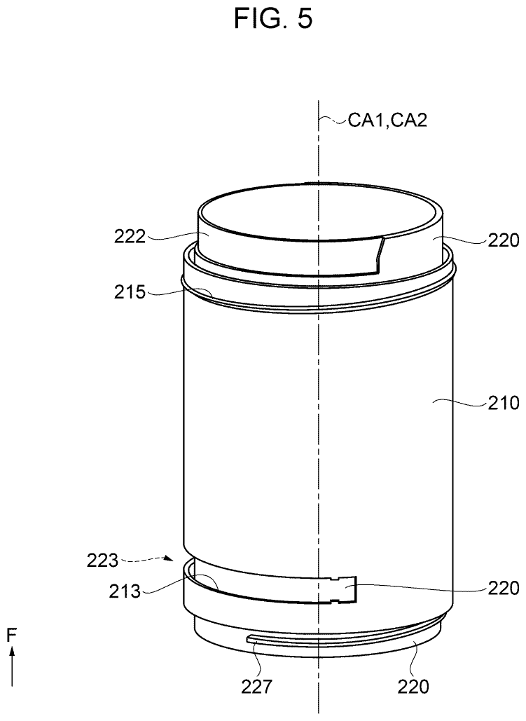

As illustrated in FIG. 5, in order to assemble the powder supply container 200, the second cylindrical portion 220 is disposed inside the first cylindrical portion 210 to overlap the first cylindrical portion 210. At this time, the groove portion 222 of the second cylindrical portion 220 is exposed in the +F direction and the male screw portion 227 of the second cylindrical portion 220 is exposed in the −F direction with respect to the first cylindrical portion 210. In addition, although not illustrated, the projection portion 223 of the second cylindrical portion 220 is fitted into the rotation restriction portion 213 of the first cylindrical portion 210. Here, a positioning projection portion may be provided on the rotation restriction portion 213 to reliably position the projection portion 223 with respect to the rotation restriction portion 213.

When the first cylindrical portion 210 and the second cylindrical portion 220 are assembled, the central axis CA1 of the first cylindrical portion 210 and the central axis CA2 of the second cylindrical portion 220 coincide with each other.

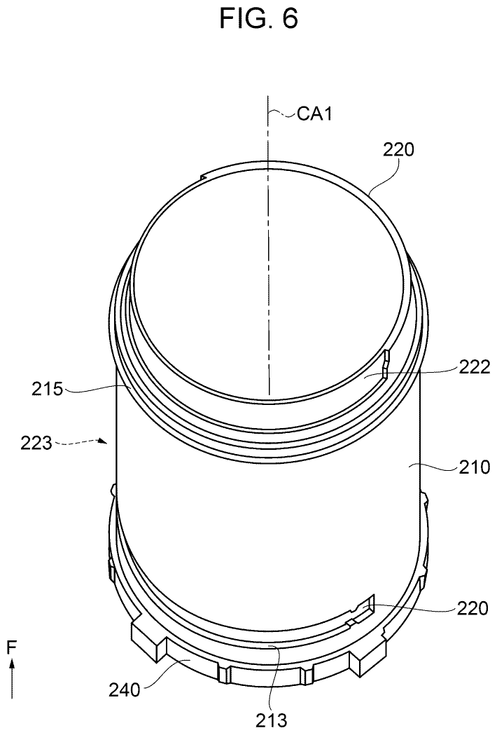

As illustrated in FIG. 6, when the powder supply container 200 is assembled, the second lid portion 240 is assembled in the −F direction to the first cylindrical portion 210 and the second cylindrical portion 220 that are overlapped. In detail, the second lid portion 240 is fixed to a −F direction end portion of the second cylindrical portion 220. Although not illustrated, at this time, the female screw portion 247 of the second lid portion 240 and the male screw portion 227 of the second cylindrical portion 220 are screwed to each other. Accordingly, the second lid portion 240 is detachably attached to the second cylindrical portion 220.

The groove portion 222 extends over substantially half the circumference of the side surface of the second cylindrical portion 220 when viewed from the +F direction. Although not illustrated, similarly, the rotation restriction portion 213 extends over substantially half the circumference of the side surface of the first cylindrical portion 210. When the first cylindrical portion 210, the second cylindrical portion 220, and the second lid portion 240 are assembled, the groove portion 222 and the rotation restriction portion 213 overlap each other when viewed from the +F direction.

In a state where the first cylindrical portion 210, the second cylindrical portion 220, and the second lid portion 240 are assembled, in other words, in a state where the first lid portion 230 is removed from the powder supply container 200 that is assembled, the inside of the powder supply container 200 can be filled with powder substantially from the +F direction.

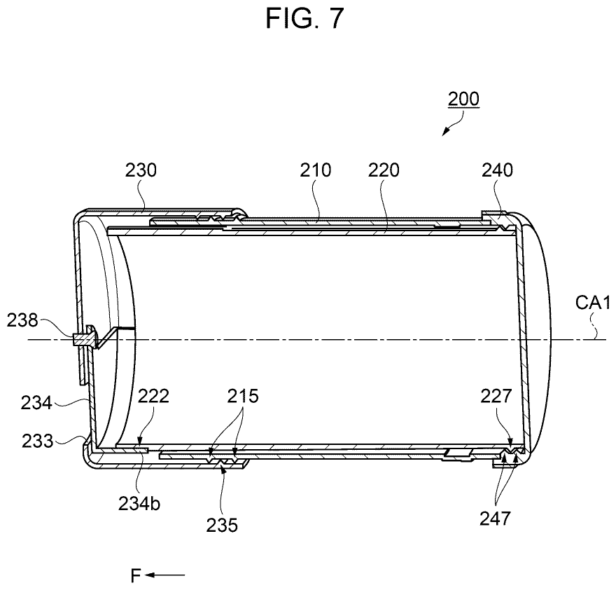

As illustrated in FIG. 7, in order to assemble the powder supply container 200, the first lid portion 230 is placed on the second cylindrical portion 220 from the +F direction, and the female screw portion 235 and the male screw portion 215 of the first cylindrical portion 210 are screwed to each other. Accordingly, the first lid portion 230 is attached and fixed to the +F direction end portion of the first cylindrical portion 210. In addition, the edge portion 234b of the shutter portion 234 is fitted into the groove portion 222.

When the powder supply container 200 is assembled, the inside of the second cylindrical portion 220 is closed by the first cylindrical portion 210, the first lid portion 230, the shutter portion 234, and the second lid portion 240. Accordingly, a space capable of containing powder and being closed is secured inside the second cylindrical portion 220.

In the powder supply container 200, the first cylindrical portion 210 is not fixed to the second cylindrical portion 220 and the second lid portion 240, but is rotatable about the central axis CA1. The first lid portion 230 is also not fixed to the second cylindrical portion 220 and the second lid portion 240, but is rotatable about the central axis CA1, together with the first cylindrical portion 210.

Since the edge portion 234b is fitted into the groove portion 222, the shutter portion 234 is restricted from moving by the groove portion 222 and is fixed to the second cylindrical portion 220. For that reason, the rotation of the shutter portion 234 is not linked to the first cylindrical portion 210 and the first lid portion 230, but follows the rotation of the second cylindrical portion 220. That is, the shutter portion 234 is rotatable about the central axis CA1 with respect to the first lid portion 230 and the opening portion 233.

The configuration in which the movement of the shutter portion 234 is restricted is not limited to the groove portion 222 and the edge portion 234b. For example, instead of the groove portion 222, a plurality of protrusions may be provided on the side surface of the +F direction end portion of the second cylindrical portion 220. An end of the edge portion 234b may abut against the plurality of protrusions, so that the rotation of the shutter portion 234 follows the rotation of the second cylindrical portion 220.

When the second lid portion 240 is rotated about the central axis CA1 with respect to the first cylindrical portion 210, the second cylindrical portion 220 also rotates about the central axis CA1. At this time, the first lid portion 230 and the opening portion 233 are not displaced, and the shutter portion 234 also rotates together with the second cylindrical portion 220. That is, the shutter portion 234 rotates with respect to the opening portion 233 to switch the opening portion 233 between opening and closing.

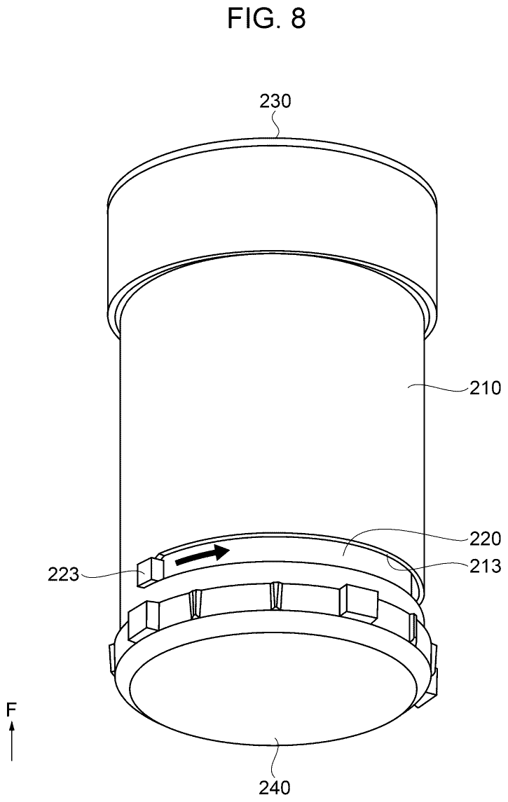

As illustrated in FIG. 8, the projection portion 223 of the second cylindrical portion 220 is fitted into the rotation restriction portion 213 of the first cylindrical portion 210, and is partially exposed from the rotation restriction portion 213. In a state where the projection portion 223 is fitted into the rotation restriction portion 213, the projection portion 223 is movable in a range where the rotation restriction portion 213 is formed. That is, the rotation restriction portion 213 restricts the rotation of the projection portion 223 with respect to the first cylindrical portion 210, and also restricts the rotation of the second cylindrical portion 220. Here, FIG. 8 illustrates a state where the opening portion 233 is closed by the shutter portion 234. The above-described state is a state where the projection portion 223 is rotated counterclockwise to its maximum with respect to the rotation restriction portion 213 when viewed from the −F direction.

In the above-described state, the projection portion 223 abuts against one end portion of the rotation restriction portion 213, and is not rotatable any further counterclockwise when viewed from the −F direction. On the other hand, the projection portion 223 is movable in the direction of an arrow in the drawing, and is rotatable clockwise until the projection portion 223 abuts against the other end portion of the rotation restriction portion 213 when viewed from the −F direction. When the projection portion 223 is rotated until the projection portion 223 abuts against the other end portion of the rotation restriction portion 213, the shutter portion 234 rotates with respect to the first lid portion 230, and the opening portion 233 is opened.

A rotation angle of the second cylindrical portion 220 with respect to the first cylindrical portion 210 is restricted by the rotation restriction portion 213 and the projection portion 223. Accordingly, the second cylindrical portion 220 does not rotate more than necessary with respect to the first cylindrical portion 210, and the rotation of the shutter portion 234 with respect to the opening portion 233 is controlled. For that reason, the opening portion 233 can be efficiently opened and closed by the shutter portion 234. The rotation angle refers to an angle of rotation about the central axis CA1 described above when viewed from the −F direction.

It is preferable that the rotation angle is in a range of from 0° to 180°. That is, when viewed from the −F direction, a state where the projection portion 223 abuts against the one end portion of the rotation restriction portion 213 is a state where the rotation angle is 0°, and a state where the projection portion 223 abuts against the other end portion of the rotation restriction portion 213 is a state where the rotation angle is 180°. When the rotation angle is 0°, the opening portion 233 is closed, and when the rotation angle is 180°, the opening portion 233 is opened. Accordingly, both an increase in the open area of the opening portion 233 and the efficient opening/closing of the opening portion 233 can be achieved.

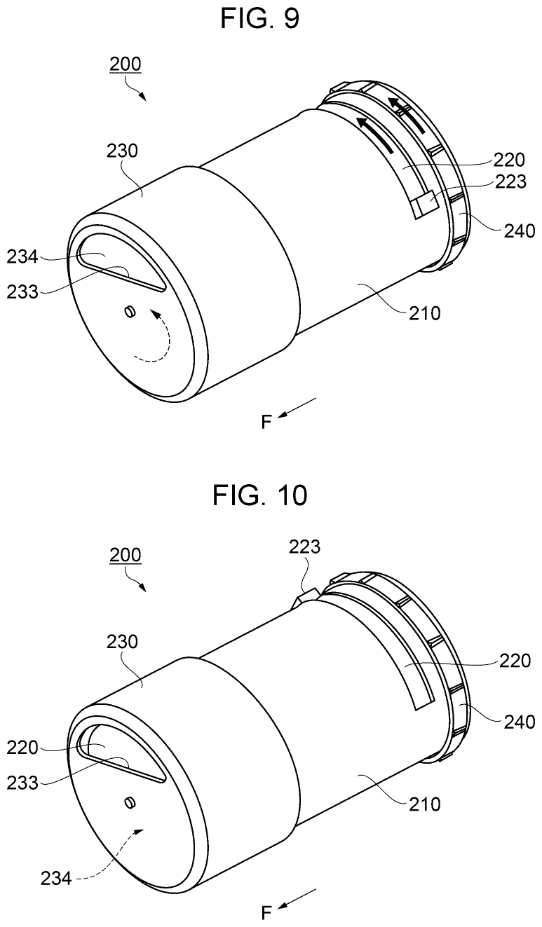

In detail, when the rotation angle is 0°, as illustrated in FIG. 9, the opening portion 233 is closed by the shutter portion 234. In this state, the projection portion 223 is abutted against the one end portion of the rotation restriction portion 213. From this state, the second lid portion 240 is rotated with respect to the first cylindrical portion 210 in the direction of an arrow, that is, clockwise when viewed from the −F direction.

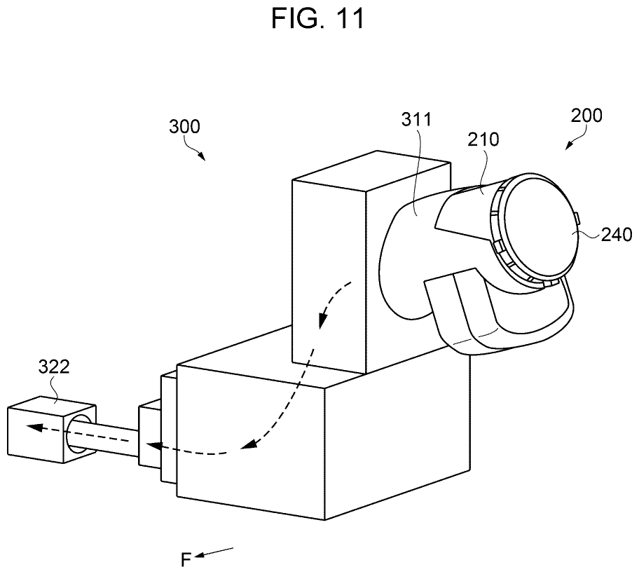

Accordingly, the projection portion 223 is also displaced in the direction of an arrow along the rotation restriction portion 213. At this time, the second cylindrical portion 220 follows the rotation of the second lid portion 240 to rotate clockwise when viewed from the −F direction. Further, the shutter portion 234 also follows the rotation of the second cylindrical portion 220 to rotate in a direction indicated by a dashed arrow. FIG. 10 illustrates a state where the projection portion 223 is abutted against the other end portion of the rotation restriction portion 213.

As illustrated in FIG. 10, by rotating the second lid portion 240, the shutter portion 234 is rotated with respect to the opening portion 233, and the opening portion 233 is opened. In this state, the powder can be supplied from the powder supply container 200. In the process of transition from the state illustrated in FIG. 9 to the state illustrated in FIG. 10, the degree of overlap between the opening portion 233 and the shutter portion 234 changes, and the open area of the opening portion 233 changes depending on the degree of overlap. In addition, the above-described positioning projection portions of the rotation restriction portion 213 may be provided at positions corresponding to both the states illustrated in FIGS. 9 and 10, or may be provided to correspond to one of both the states.

The first lid portion 230 and the second lid portion 240 have been described as being attachable and detachable; however, the present disclosure is not limited thereto. One of the first lid portion 230 and the second lid portion 240 may be formed integrally with the first cylindrical portion 210.

Next, a powder supply mechanism 300 for applying the powder supply container 200 to a sheet manufacturing apparatus will be described. The powder supply mechanism 300 illustrated in FIG. 11 is included in a sheet manufacturing apparatus 1 to be described later. The powder supply mechanism 300 supplies the powder from the powder supply container 200 to a channel, which will be described later, included in the sheet manufacturing apparatus 1.

The powder supply mechanism 300 includes a mounting portion 311, a supply portion 322, and a valve (not illustrated). The mounting portion 311 has a circular cross section perpendicular to the F-axis, and the powder supply container 200 can be inserted into the circle.

After an operator fills the powder supply container 200 with powder and closes the opening portion 233, the operator inserts the powder supply container 200 into the mounting portion 311 from a first lid portion 230 side. In this state, the powder with which the powder supply container 200 is filled is not supplied to the powder supply mechanism 300.

Next, the operator holds the first cylindrical portion 210 using one hand, and rotates the second lid portion 240 clockwise when viewed from the −F direction using the other hand. The second lid portion 240 is rotated until the second lid portion 240 cannot be rotated, that is, until the projection portion 223 abuts against the other end portion of the rotation restriction portion 213 and stops rotating. Accordingly, the opening portion 233 (not illustrated) is opened, and the powder in the powder supply container 200 is supplied to the inside of the powder supply mechanism 300.

The powder supplied from the powder supply container 200 travels through the powder supply mechanism 300 along a path indicated by dashed arrows, and the flow rate is adjusted by the valve in the middle of the path. The powder is supplied from the supply portion 322 to the sheet manufacturing apparatus 1 at a predetermined flow rate.

The powder supply container 200 that completes the supply of the powder is removed from the mounting portion 311 after the second lid portion 240 is rotated to close the opening portion 233. The powder supply container 200 can be used repeatedly.

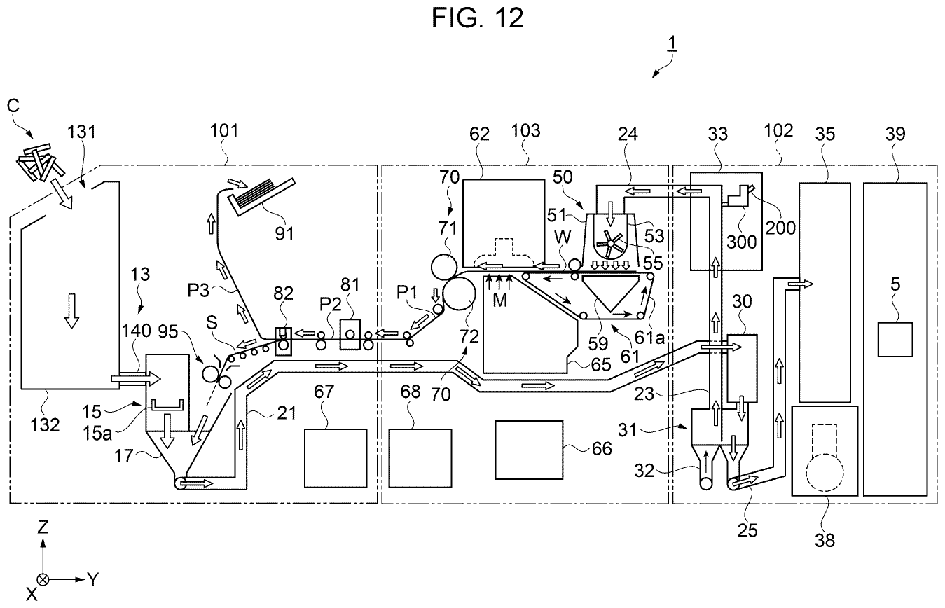

The sheet manufacturing apparatus 1 to which the powder supply container 200 can be applied will be described with reference to FIG. 12. In FIG. 12, X-, Y-, and Z-axes are designated as coordinate axes orthogonal to each other, a direction indicated by each arrow is a +direction, and a direction opposite to the +direction is a −direction.

FIG. 12 illustrates a state where the sheet manufacturing apparatus 1 is installed on a horizontal surface. The Z-axis is along a vertical direction, a +Z direction is also referred to as upward, and a −Z direction is also referred to as downward. The −Z direction is a direction in which gravity acts. For convenience of illustration, the size of each member is different from the actual size.

The sheet manufacturing apparatus 1 manufactures sheets P3 from paper pieces using a dry method. The sheet manufacturing apparatus to which the powder supply container 200 is applied is not limited to being of a dry type, and may be of a wet type. In the present specification, the “dry method” refers to a method not being performed in a liquid but a method being performed in air such as the atmosphere. Sheets may be manufactured from other fibers such as cotton or fabric, instead of paper pieces.

As illustrated in FIG. 12, the sheet manufacturing apparatus 1 according to the present embodiment includes a first unit group 101, a second unit group 102, and a third unit group 103. The first unit group 101, the second unit group 102, and the third unit group 103 are supported by a frame (not illustrated).

In FIG. 12, directions in which paper pieces C, the sheets P3, slit pieces S, unnecessary trimmings, and the like move are indicated by white arrows. In the sheet manufacturing apparatus 1, a leading side in a transport direction of the paper pieces C, a web W, the sheet P3, and the like may be referred to as downstream, and a trailing side in the transport direction may be referred to as upstream. In the following description, a collection of the paper pieces C composed of a plurality of paper pieces C is also simply referred to as the paper piece C.

The sheet manufacturing apparatus 1 manufactures the sheets P3 from the paper pieces C. In the sheet manufacturing apparatus 1, in side view from a −X direction, the first unit group 101, the third unit group 103, and the second unit group 102 are disposed from a −Y direction toward a +Y direction.

The paper pieces C are transported from the first unit group 101 to the second unit group 102 via a pipe 21 that traverses the third unit group 103. Then, the paper pieces C are subjected to defibration or the like in the second unit group 102 to become fibers, and then are made into a mixture containing a binder or the like. The mixture is transported to the third unit group 103 via a pipe 24. The mixture is made into the web W in the third unit group 103, and then is formed into a strip-shaped sheet P1. The strip-shaped sheet P1 is cut in the first unit group 101 to become the sheets P3.

The first unit group 101 includes a raw material supply device 13, a measurement unit 15, a merging unit 17, and the pipe 21. In the first unit group 101, these configurations are disposed in the above-described order from upstream toward downstream. In addition, the first unit group 101 also includes a first cutting unit 81, a second cutting unit 82, a tray 91, and a shredding unit 95. The first cutting unit 81 and the second cutting unit 82 cut the strip-shaped sheet P1 into the sheets P3 having a predetermined shape. Further, the first unit group 101 includes a water supply unit 67. The water supply unit 67 is a water storage tank. The water supply unit 67 supplies water for humidification to each of a first humidifying unit 65 and a second humidifying unit 66 to be described later through a water supply pipe (not illustrated).

The raw material supply device 13 stores the paper pieces C that are a raw material for the sheets P3, and supplies the paper pieces C downstream. The raw material supply device 13 includes a raw material inlet 131, a storage portion 132, and a discharge portion 140.

The paper pieces C are input to the storage portion 132 from the raw material inlet 131. The paper pieces C contain fibers such as cellulose, and are, for example, shredded waste paper. Humidified air is supplied to the inside of the storage portion 132 from the second humidifying unit 66 provided in the third unit group 103.

The paper pieces C are temporarily stored in the storage portion 132, and then are transported to the measurement unit 15 via the discharge portion 140. The sheet manufacturing apparatus 1 may include a shredder, which shreds the paper pieces C and the like, upstream of the storage portion 132.

The measurement unit 15 includes a sensor unit 15a and a supply mechanism (not illustrated). The sensor unit 15a measures the mass of the paper pieces C. The supply mechanism supplies the paper pieces C, which are weighed by the sensor unit 15a, to the downstream merging unit 17. That is, the measurement unit 15 weighs the paper pieces C to a predetermined mass using the sensor unit 15a, and supplies the paper pieces C to the downstream merging unit 17 using the supply mechanism.

Both digital and analog weighing mechanisms can be applied to the sensor unit 15a. Specifically, examples of the sensor unit 15a include a physical sensor such as a load cell, a spring balance, a balance, and the like. In the present embodiment, a load cell is used as the sensor unit 15a. The predetermined mass to which the sensor unit 15a weighs the paper pieces C is, for example, approximately several grams to several tens of grams.

A known technique such as an openable/closable feeder can be applied to the supply mechanism. The supply mechanism may be included in the sensor unit 15a.

The weighing and supply of the paper pieces C by the measurement unit 15 is a batch process. That is, the supply of the paper pieces C from the measurement unit 15 to the merging unit 17 is performed intermittently. The measurement unit 15 may include a plurality of combinations of the sensor units 15a and the supply mechanisms, and may improve the efficiency of weighing and supply by operating the plurality of sensor units 15a at intervals. The sheet manufacturing apparatus 1 includes two sensor units 15a and the supply mechanisms attached to the respective sensor units 15a. Accordingly, the paper pieces C are alternately transported from two sets of the sensor units 15a and the supply mechanisms to the merging unit 17.

In the merging unit 17, the shredded slit pieces S supplied from the shredding unit 95 are merged and mixed with the paper pieces C supplied from the measurement unit 15. The slit pieces S and the shredding unit 95 will be described later. The paper pieces C mixed with the shredded pieces flow into the pipe 21 from the merging unit 17.

The pipe 21 transports the paper pieces C from the first unit group 101 to the second unit group 102 using a suction airflow generated by a downstream defibrating unit 30.

The second unit group 102 includes the defibrating unit 30 that is a dry type defibrator, a separating unit 31, a pipe 23, a mixing unit 33, and the pipe 24. In the second unit group 102, these configurations are disposed in the above-described order from upstream toward downstream. In addition, the second unit group 102 also includes a pipe 25 connected to the separating unit 31, a recovery unit 35, a compressor 38, and a power supply unit 39.

The paper pieces C transported through the pipe 21 flow into the defibrating unit 30. The defibrating unit 30 defibrates the paper pieces C, which are supplied from the measurement unit 15, into fibers using a dry method. A known defibrating mechanism can be applied to the defibrating unit 30.

The defibrating unit 30 has, for example, the following configuration. The defibrating unit 30 includes a stator and a rotor. The stator has a substantially cylindrical inner surface. The rotor is installed inside the stator, and rotates along the inner surface of the stator. The small paper pieces C are pinched between the inner surface of the stator and the rotor, and are defibrated by a shearing force generated therebetween. Accordingly, regarding the paper pieces C, entangled fibers contained in the paper pieces are disentangled. The paper pieces C are made into fibers, and are transported to the separating unit 31.

The separating unit 31 sorts the defibrated fibers. In detail, the separating unit 31 removes components that are contained in the fibers and that are unnecessary for the manufacture of the sheets P3. Specifically, the separating unit 31 sorts relatively short fibers from relatively long fibers. Since the relatively short fibers may cause a decrease in the strength of the sheets P3, the relatively short fibers are sorted by the separating unit 31. In addition, the separating unit 31 also sorts and removes coloring materials, additives, or the like contained in the paper pieces C. A known technique such as a disk mesh method can be applied to the separating unit 31.

Humidified air is supplied to the inside of the separating unit 31 from the second humidifying unit 66 of the third unit group 103.

Relatively short fibers and the like are removed from the defibrated fibers, and the defibrated fibers are transported to the mixing unit 33 via the pipe 23 by an airflow generated by a blower (not illustrated) disposed at a tip of an airflow pipe 32. Unnecessary components such as relatively short fibers or coloring materials are discharged to the recovery unit 35 via the pipe 25.

The mixing unit 33 mixes a powder additive such as a binder with the fibers in the air to form a mixture. The mixing unit 33 includes the powder supply mechanism 300. The powder supply mechanism 300 includes a built-in hopper in addition to the supply portion 322 and the valve described above. The powder supply container 200 is mounted on the powder supply mechanism 300. Although not illustrated, the mixing unit 33 includes a channel through which the fibers are transported and a fan, in addition to the powder supply mechanism 300.

The hopper communicates with the channel for the fibers via the supply portion 322. The valve is provided in the supply portion 322 between the hopper and the channel. The hopper sends the binder powder, which is supplied from the powder supply container 200, into the channel. In the sheet manufacturing apparatus 1, starch is adopted as the binder for the fibers. The valve adjusts the flow rate, that is, the mass of the binder supplied from the hopper to the channel. Accordingly, the mixing ratio of the fibers and the binder is adjusted.

The mixing unit 33 may include a similar configuration for supplying a coloring material, an additive, or the like, in addition to the powder supply container 200 and the powder supply mechanism 300 that supply the binder. That is, the powder supply container 200 may be applied to an additive or a coloring material other than the binder.

The fan of the mixing unit 33 forms a mixture by mixing the binder and the like with the fibers in the air while transporting the fibers downstream using a generated airflow. The mixture flows into the pipe 24 from the mixing unit 33.

The recovery unit 35 includes a filter (not illustrated). The filter filters unnecessary components such as relatively short fibers transported through the pipe 25 by the airflow.

The compressor 38 generates compressed air. The filter may be clogged with fine particles or the like among the unnecessary components. The filter can be cleaned by blowing the compressed air, which is generated by the compressor 38, onto the filter to blow off adhering particles.

The power supply unit 39 includes a control unit 5 and a power supply device (not illustrated) that supplies electric power to the sheet manufacturing apparatus 1. The power supply unit 39 distributes electric power, which is supplied from the outside, to each configuration of the sheet manufacturing apparatus 1. The control unit 5 is electrically connected to each configuration of the sheet manufacturing apparatus 1, and comprehensively controls the operation of these configurations.

The third unit group 103 accumulates and compresses the mixture containing the fibers to form the strip-shaped sheet P1 that is recycled paper. The third unit group 103 includes an accumulating unit 50, a first transport unit 61, a second transport unit 62, the first humidifying unit 65, the second humidifying unit 66, a drainage unit 68, and a forming unit 70.

In the third unit group 103, the accumulating unit 50, the first transport unit 61, the second transport unit 62, the first humidifying unit 65, and the forming unit 70 are disposed in order from upstream toward downstream. The second humidifying unit 66 is disposed below the first humidifying unit 65.

The accumulating unit 50 accumulates the mixture containing the sorted fibers in the air to generate the web W. The accumulating unit 50 includes a drum member 53, a blade member 55 installed inside the drum member 53, a housing 51 that accommodates the drum member 53, and a suction unit 59. The mixture is taken into the inside of the drum member 53 from the pipe 24.

The first transport unit 61 is disposed below the accumulating unit 50. The first transport unit 61 includes a mesh belt 61a and five tension rollers (not illustrated) for tensioning the mesh belt 61a. The suction unit 59 faces the drum member 53 with the mesh belt 61a interposed therebetween in a direction along the Z-axis.

The blade member 55 is disposed inside the drum member 53, and is rotationally driven by a motor (not illustrated). The drum member 53 is a semi-columnar sieve. A mesh having the function of a sieve is provided on a side surface of the drum member 53, the side surface facing downward. The drum member 53 allows particles such as the fibers or mixture, which are smaller than the mesh opening size of the sieve, to pass therethrough from the inside to the outside.

The mixture is discharged to the outside of the drum member 53 while being stirred by the blade member 55 rotating inside the drum member 53. Humidified air is supplied to the inside of the drum member 53 from the second humidifying unit 66.

The suction unit 59 is disposed below the drum member 53. The suction unit 59 suctions air inside the housing 51 via a plurality of holes of the mesh belt 61a. The plurality of holes of the mesh belt 61a allow air to pass therethrough, but make it difficult for the fibers, the binder, or the like contained in the mixture to pass therethrough. Accordingly, the mixture discharged to the outside of the drum member 53 is suctioned downward together with the air. The suction unit 59 is a known suction device such as a blower.

The mixture is dispersed in the air inside the housing 51, and is accumulated on an upper surface of the mesh belt 61a due to gravity and the suction of the suction unit 59 to become the web W.

The mesh belt 61a is an endless belt, and is tensioned by the five tension rollers. The mesh belt 61a is rotated counterclockwise in FIG. 12 by the rotation of the tension rollers. Accordingly, the mixture is continuously accumulated on the mesh belt 61a to form the web W. The web W contains a relatively large amount of air, and is soft and swollen. The first transport unit 61 transports the formed web W downstream through the rotation of the mesh belt 61a.

The second transport unit 62 is located downstream of the first transport unit 61, and transports the web W in place of the first transport unit 61. The second transport unit 62 peels the web W from the upper surface of the mesh belt 61a, and transports the web W toward the forming unit 70. The second transport unit 62 is disposed above a transport path of the web W and slightly upstream of a starting point on the return side of the mesh belt 61a. The +Y direction of the second transport unit 62 and the −Y direction of the mesh belt 61a partially overlap each other in the vertical direction.

The second transport unit 62 includes a transport belt, a plurality of rollers, and a suction mechanism that are not illustrated. The transport belt is provided with a plurality of holes through which air passes. The transport belt is tensioned by the plurality of rollers, and is rotated by the rotation of the rollers.

The second transport unit 62 causes an upper surface of the web W to be suctioned to a lower surface of the transport belt using negative pressure generated by the suction mechanism. As the transport belt rotates in this state, the web W is suctioned to the transport belt and is transported downstream.

The first humidifying unit 65 humidifies the web W containing fibers that is accumulated by the accumulating unit 50 of the third unit group 103. In detail, the first humidifying unit 65 is, for example, a mist humidifier, and humidifies the web W, which is transported by the second transport unit 62, by supplying mist M to the web W from below. The first humidifying unit 65 is disposed below the second transport unit 62, and faces the web W, which is transported by the second transport unit 62, in the direction along the Z-axis. For example, a known humidifying device such as an ultrasonic type can be applied as the first humidifying unit 65.

By humidifying the web W with the mist M, the function of starch as a binder is promoted, and the strength of the sheets P3 is improved. In addition, since the web W is humidified from below, droplets derived from the mist are prevented from falling onto the web W. Further, since the web W is humidified from a side opposite to a contact surface between the transport belt and the web W, sticking of the web W to the transport belt is reduced. The second transport unit 62 transports the web W to the forming unit 70.

The forming unit 70 includes processing rollers 71 and 72. The processing rollers 71 and 72 compress the web W containing fibers to form the strip-shaped sheet P1. The processing rollers 71 and 72 form a pair, include respective built-in electric heaters, and have the function of increasing the temperature of the surfaces of the rollers.

Each of the processing rollers 71 and 72 is a substantially columnar member. A rotating shaft of the processing roller 71 and a rotating shaft of the processing roller 72 are disposed along the X-axis. The processing roller 71 is disposed substantially above the transport path of the web W, and the processing roller 72 is disposed substantially below the transport path. A gap corresponding to the thickness of the sheet P3 to be manufactured is provided between a side surface of the processing roller 71 and a side surface of the processing roller 72.

The processing rollers 71 and 72 are rotationally driven by a stepping motor (not illustrated). The web W is sent downstream while being pinched between the processing roller 71 and the processing roller 72 and being heated and pressurized. That is, the web W continuously passes through the forming unit 70, and is press-formed while being heated. The web W can be efficiently heated and pressurized by using the processing rollers 71 and 72 as a pair of forming members.

As the web W passes through the forming unit 70, the amount of air contained in the web W is reduced from a state where the web W contains a relatively large amount of air and is soft, and the fibers are bound to each other by the binder to form the strip-shaped sheet P1. The strip-shaped sheet P1 is transported to the first unit group 101 by a transport roller (not illustrated).

The second humidifying unit 66 is disposed below the first humidifying unit 65. A known evaporative humidifying device can be applied as the second humidifying unit 66. Examples of the evaporative humidifying device include a humidifying device that generates humidified air by blowing air onto a wet non-woven fabric or the like to evaporate moisture.

The second humidifying unit 66 humidifies a predetermined region of the sheet manufacturing apparatus 1. The predetermined region is one or more of the storage portion 132, the separating unit 31, and the inside of the drum member 53 of the accumulating unit 50. Specifically, the humidified air is supplied from the second humidifying unit 66 to the above-described regions via a plurality of pipes (not illustrated). In each configuration described above, the humidified air suppresses the electrostatic charge of the paper pieces C, fibers, or the like, and suppresses adhesion of the paper pieces C, fibers, or the like to members caused by static electricity.

The drainage unit 68 is a drainage tank. The drainage unit 68 collects and stores waste moisture that is used in the first humidifying unit 65, the second humidifying unit 66, and the like. The drainage unit 68 can be detached from the sheet manufacturing apparatus 1 if necessary, and the accumulated water can be discarded.

The strip-shaped sheet P1 transported to the first unit group 101 reaches the first cutting unit 81. The first cutting unit 81 cuts the strip-shaped sheet P1 in a direction intersecting the transport direction, for example, in a direction along the X-axis. The strip-shaped sheet P1 is cut into cut sheets P2 by the first cutting unit 81. The cut sheets P2 are transported from the first cutting unit 81 to the second cutting unit 82.

The second cutting unit 82 cuts the cut sheets P2 in the transport direction, for example, in a direction along the Y-axis. In detail, the second cutting unit 82 cuts the vicinities of edges on both sides of the cut sheets P2 in the direction along the X-axis. Accordingly, each cut sheet P2 becomes, for example, the sheet P3 having a predetermined shape such as an A4 size or an A3 size.

When each cut sheet P2 is cut into the sheet P3 by the second cutting unit 82, the slit pieces S that are trimmings are generated. The slit pieces S are transported substantially in the-Y direction, and reach the shredding unit 95 that is a shredder. The shredding unit 95 shreds the slit pieces S into shredded pieces, and the shredded pieces are supplied to the merging unit 17. A mechanism for weighing and supplying the shredded slit pieces S to the merging unit 17 may be installed between the shredding unit 95 and the merging unit 17.

The sheets P3 are transported substantially upward, and are stacked in the tray 91. As described above, the sheets P3 are manufactured by the sheet manufacturing apparatus 1. The sheets P3 can be applied, for example, as substitutes for copy paper or the like.

According to the present embodiment, the following effects can be obtained.

Transport of powder in a filled state is facilitated. In detail, since the inside of the second cylindrical portion 220 is closed, the powder is prevented from leaking even when the inside is filled with the powder and is carried. It is possible to provide the powder supply container 200 that is easy to carry in a state where the powder supply container 200 is filled with the powder.

By removing the first lid portion 230, the inside of the second cylindrical portion 220 can be easily filled with the powder. In addition, since the inside of the second cylindrical portion 220 can be opened and closed by the opening portion 233 and the shutter portion 234, the powder can be supplied to the sheet manufacturing apparatus 1 or the like via the opening portion 233 in a simple manner.

What is claimed is:

1. A powder supply container comprising: a first case having an internal space having a columnar shape;
a second case disposed to overlap the internal space to be rotatable around a central axis of the internal space;
a first lid including an opening portion;
a second lid; and
a shutter, wherein
the first lid closes a first direction side of the central axis of the internal space in a state where the opening portion is closed by the shutter,
the second lid closes a second direction side of the central axis of the internal space opposite to a first direction, and
the shutter follows a rotation of the second case to open and close the opening portion.

2. The powder supply container according to claim 1, wherein
the first case includes a rotation restriction portion that is a through-hole, and
the second case is rotated by the powder supply container through the rotation restriction portion when the powder supply container is mounted on a sheet manufacturing apparatus.

3. The powder supply container according to claim 2, wherein an angle of the rotation of the second case is in a range of from 0° to 180°.
